(19) United States
(12) Patent Application Publication
(10) Pub. No.: US 2007/0170872 A1
(43) Pub. Date: Jul. 26, 2007

(54) Control device for multiple lamp currents of liquid crystal display backlight source

(76) Inventors: Cheng-Chia Hsu, Chupei City (TW); Teng-Kang Chang, Jhudong Township (TW); Teng-Ho Wu, Yongkang City (TW); Ho-Wen Chen, Rueifang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/335,656

(22) Filed: Jan. 20, 2006

(51) Int. Cl. H05B 41/16

(52) U.S. Cl. 315/274

(57) ABSTRACT

A control device for multiple lamp currents of a liquid crystal display (LCD) backlight source, comprising an electronic power switch, a transformer, an inverter and an IC pulse width modulation (PWM) control module. The transformer has a primary side connected to the electronic power switch and a secondary side having two ends each connected to an end of a set of lamp composed of two lamps. The inverter has two sets of coil connected to the other end of the two sets of lamp. The IC PWM control module is connected between the inverter and the electronic power switch and through which the currents flown through the two sets of lamp may be balanced. Meanwhile, the current flown through the inverter is feedback to the IC PWM control module by which a control signal is outputted to the electronic power switch by determining and processing the feedback current, thereby controlling an output signal from the electronic power switch. Therefore, luminance of the multiple lamps may be controlled and maintained.

### BACKGROUND OF THE INVENTION

1. Field of the Invention

The present invention relates to a control device for multiple lamp currents of a liquid crystal display (LCD) backlight source. More particularly, the present invention relates to a control device for multiple lamp currents of a LCD backlight source, through which luminance of the lamps of the LCD backlight source may be maintained balanced.

2. Description of the Prior Art

Referring to FIG. 1, an architecture diagram of a conventional control circuit of multiple lamp currents in a liquid crystal display (LCD) backlight source is shown therein. As shown, the multiple lamps in the LCD backlight source are controlled in the following manner. An electronic power switch 12 is connected to a primary side of a transformer 11 and four lamps are connected at one side in parallel to a secondary side of the transformer 11. At the other end of the four lamps 13, three inverters 14 are connected at one end, which are connected to an IC PWM control module 15 at the other end. Further, the IC PWM control module 15 is connected to the electronic power switch 12. As such, the control circuit for the multiple lamps 1 is completely formed. By means of the IC PWM control module 15, a feedback current signal is detected and determined and processed. Then, a control signal is outputted to the electronic power switch 12 by which an output signal from the electronic power switch 12 is controlled, thereby achieving control and maintenance of uniform luminance of the lamps.

In view of the above discussion, the conventional control circuit for the multiple lamps still has some shortcomings to be addressed and thus has to be improved. Accordingly, the Inventors have paid many efforts in the related research and finally developed successfully a control device for lamp currents of a LCD backlight, which is taken as the present invention.

### SUMMARY OF THE INVENTION

It is, therefore, an object of the present invention to provide a control device for multiple lamp currents of a liquid crystal display (LCD) backlight source, which may efficiently balance the multiple lamp currents so that a uniform luminance may be achieved over the multiple lamps in the LCD backlight source.

It is another object of the present invention to provide a control device for the multiple lamp currents of the LCD backlight source, which is provided with the advantages of higher stability, lengthened lifetime, reduced cost, smaller transformer and saved layout space.

The control device for the multiple lamps of the LCD backlight source comprises an electronic power switch, a transformer, an inverter and an IC PWM control module. The transformer has a primary side connected to the electronic power switch and a secondary side having two ends each connected to an end of a set of lamp composed of two lamps. The inverter has two sets of coil connected to the other end of the two sets of lamp. The IC PWM control module is connected between the inverter and the electronic power switch and through which the currents flown through the two sets of lamp may be balanced. Meanwhile, the current flown through the inverter is feedback to the IC PWM control module by which a control signal is outputted to the electronic power switch, thereby controlling an output signal from the electronic power switch. Therefore, luminance of the multiple lamps in the LCD backlight source may be controlled and maintained.

### BRIEF DESCRIPTION OF THE DRAWINGS

The drawings disclose illustrative embodiments of the present invention which serve to exemplify the various advantages and objects hereof, and are as follows:

FIG. 1 is an architecture diagram of a conventional control circuit for multiple lamp currents of a liquid crystal display (LCD) backlight source;

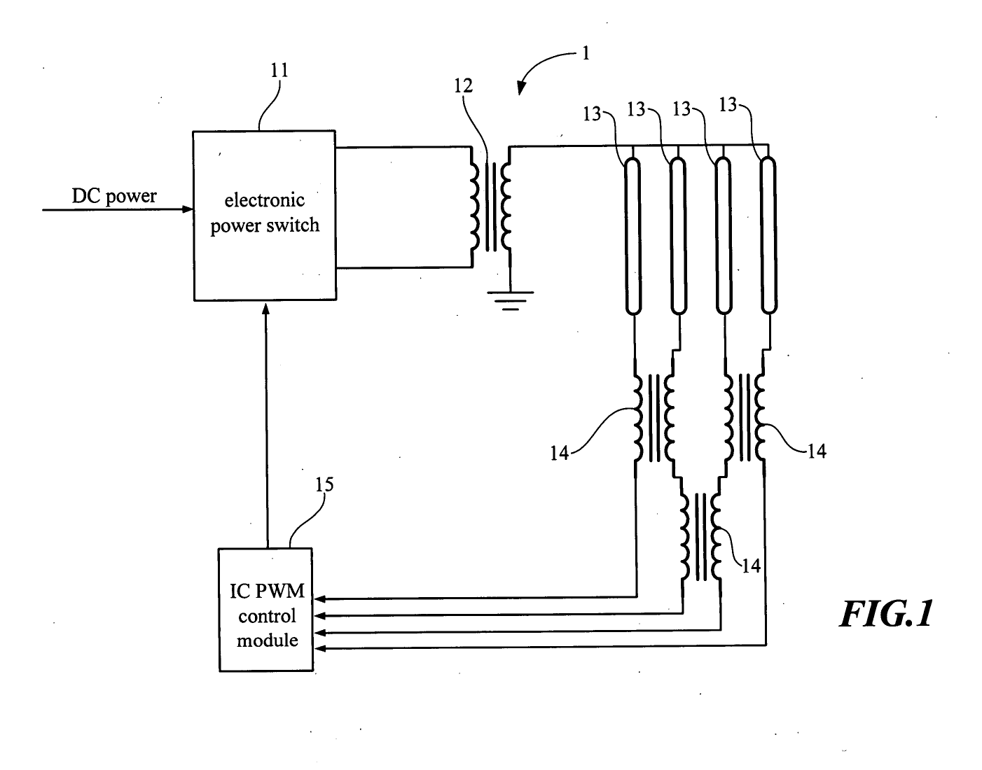

FIG. 2A is a circuit diagram of a control device for multiple lamp currents of a light liquid display (LCD) backlight source according to a first embodiment of the present invention;

FIG. 2B is a circuit diagram of a control device for multiple lamp currents of a light liquid display (LCD) backlight source according to one of examples of a first embodiment of the present invention;

FIG. 3 is a circuit diagram of the control device for the multiple lamp currents of the LCD backlight source according to a second embodiment of the present invention; and

FIG. 4 is a circuit diagram of the control device for the multiple lamp currents of the LCD backlight source according to a third embodiment of the present invention.

FIG. 5 is a circuit diagram of the control device for the multiple lamp currents of the LCD backlight source according to a fourth embodiment of the present invention.

### DETAILED DESCRIPTION OF THE PREFERRED EMBODIMENT

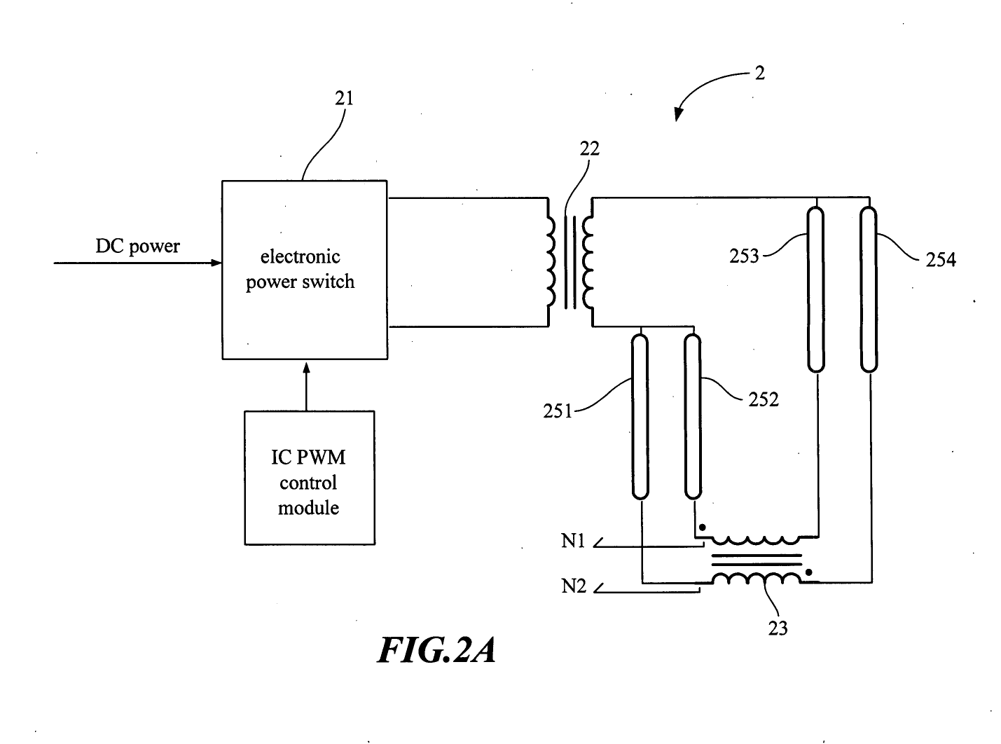

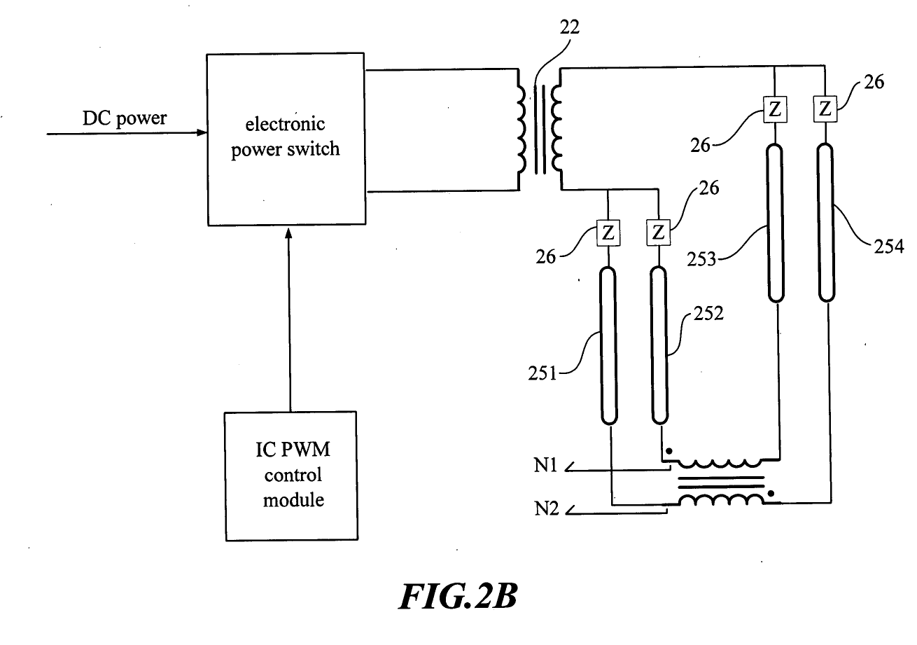

Referring to FIG. 2A, a circuit diagram of a control device for multiple lamp currents of a light liquid display (LCD) backlight source according to a first embodiment of the present invention is shown therein. As shown, the control device 2 comprises an electronic power switch 21, a transformer 22, an inverter 23 and an IC PWM control module 24. The transformer 22 has a primary side and a secondary side, the primary side being connected to the electronic power switch 21 and the secondary side having two ends each connected to one end of a set of lamp composed of two lamps 251,252,253,254. The other end of each of the lamps 241,252,253,254 is connected to the inverter 23 having two sets of coil, N1 and N2, wherein N1=N2 and each has a reverse direction with respect to a current flown therethrough as compared to the other. The first, second, third and fourth lamps 251,252,253,254 are connected to an output end of the coil N2, an input end of the coil N1, an output end of the coil N1 and an input end of the coil N2, respectively. By means of the inverter 23, a current flown through each of the four lamps 251,252,253,254 is balanced. Further, the IC PWM control module 24 is connected to the electronic power switch 21 so as to control the signal issued from the electronic power switch 21. As such, luminance of the multiple lamps may be controlled and maintained.

Referring to FIG. 2B, a circuit diagram of a control device for multiple lamp currents of a LCD backlight source according to one example of the first embodiment of the present invention is shown therein. This example is identical to that described in the above except that a resistance 26 is provided between the inverter 22 and the lamps 251,252,253,254 so as to provide resistance matching, thereby enhancing balance of the lamp currents in the LCD backlight source.

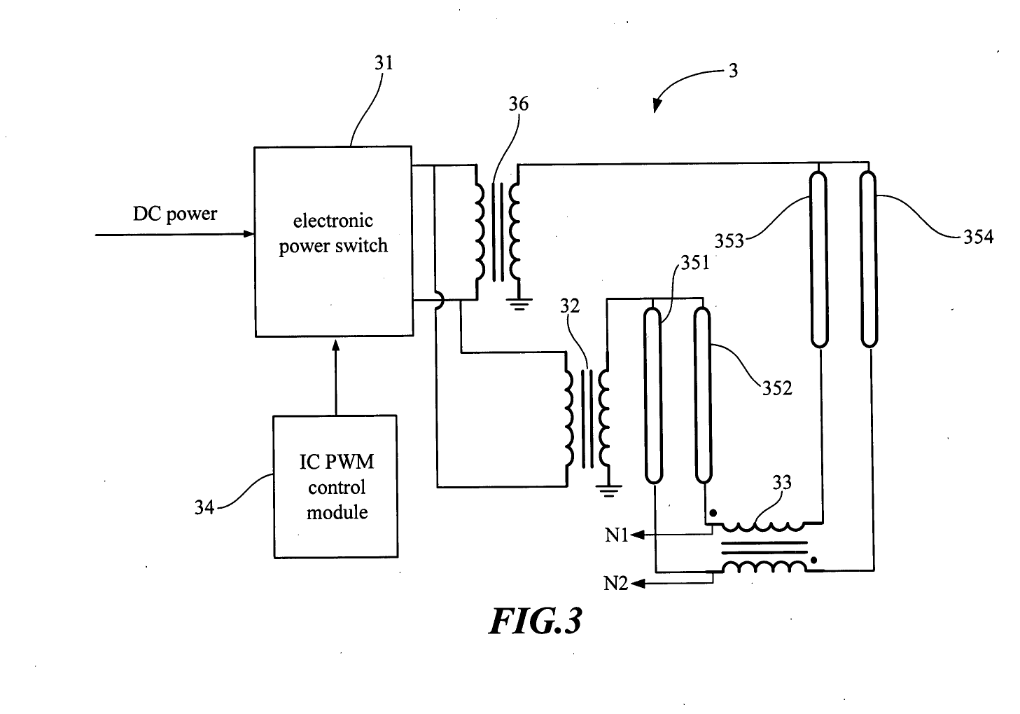

Referring to FIG. 3, a circuit diagram of a control device for multiple lamp currents of a LCD backlight source according to a second embodiment of the present invention is shown therein. As shown, the control device 3 comprises an electronic power switch 31, transformers 32, 36, an inverter 23 and an IC PWM control module 34. The transformer 32 has a primary side and a secondary side, the primary side being connected to the electronic power switch 31 and the secondary side being connected to one end of a set of lamp composed of two lamps 351, 352. The transformer 36 has a primary side and a secondary side, the primary side being also connected to the electronic power switch 31 and the secondary side being connected to one end of a set of lamp composed of two lamps. The other end of each of the lamps 351, 352, 353, 354 is connected to the inverter 33 having two sets of coil, N1 and N2, wherein N1=N2 and each has a reverse direction with respect to a current flown therethrough as compared to the other. The first, second, third and fourth lamps 351, 352, 353, 354 are connected to an output end of the coil N2, an input end of the coil N1, an output end of the coil N1 and an input end of the coil N2, respectively. By means of the inverter 23, the current flown through each of the four lamps 351, 352, 353, 354 is balanced. Further, the IC PWM control module 34 is connected to the electronic power switch 31 so as to control the signal issued from the electronic power switch 31. As such, the luminance of the multiple lamps may be controlled and maintained. N1=N2.

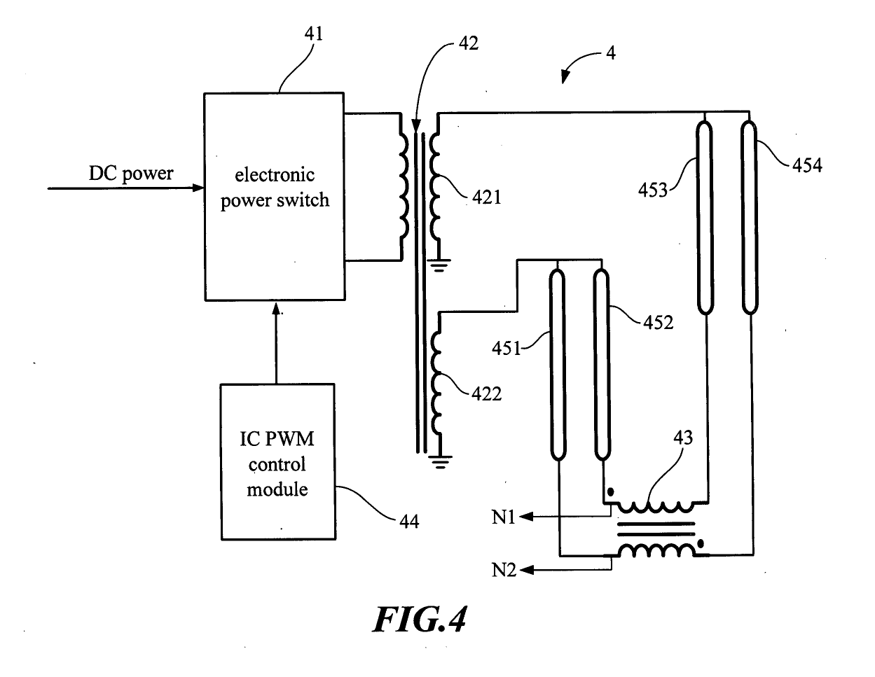

Referring to FIG. 4, a circuit diagram of a control device for multiple lamp currents of a LCD backlight source according to a third embodiment of the present invention is shown therein. As shown, the control device 4 comprises an electronic power switch 41, a transformer 42 having two output coils, an inverter 43 and an IC PWM control module 44. The transformer 42 has a primary side and a secondary side, the primary side being connected to the electronic power switch 41 and the secondary side being connected to the first output coil 421 and the second coil 422. The first output coil 421 is connected to two lamps 453,454 and the second output coil 422 is connected to two lamps 451, 452. The other end of each of the lamps 451, 452, 453, 454 is connected to the inverter 43 having two sets of coil, N1 and N2, wherein N1=N2 and each has a reverse direction with respect to a current flown therethrough as compared to the other. The first, second, third and fourth lamps 451, 452, 453, 454 are connected to an output end of the coil N2, an input end of the coil N1, an output end of the coil N1 and an input end of the coil N2, respectively. By means of the inverter 43, the current flown through each of the four lamps 451, 452, 453, 454 is balanced. Further, the IC PWM control module 44 is connected to the electronic power switch 41 so as to control the signal issued from the electronic power switch 41. As such, the luminance of the multiple lamps may be controlled and maintained.

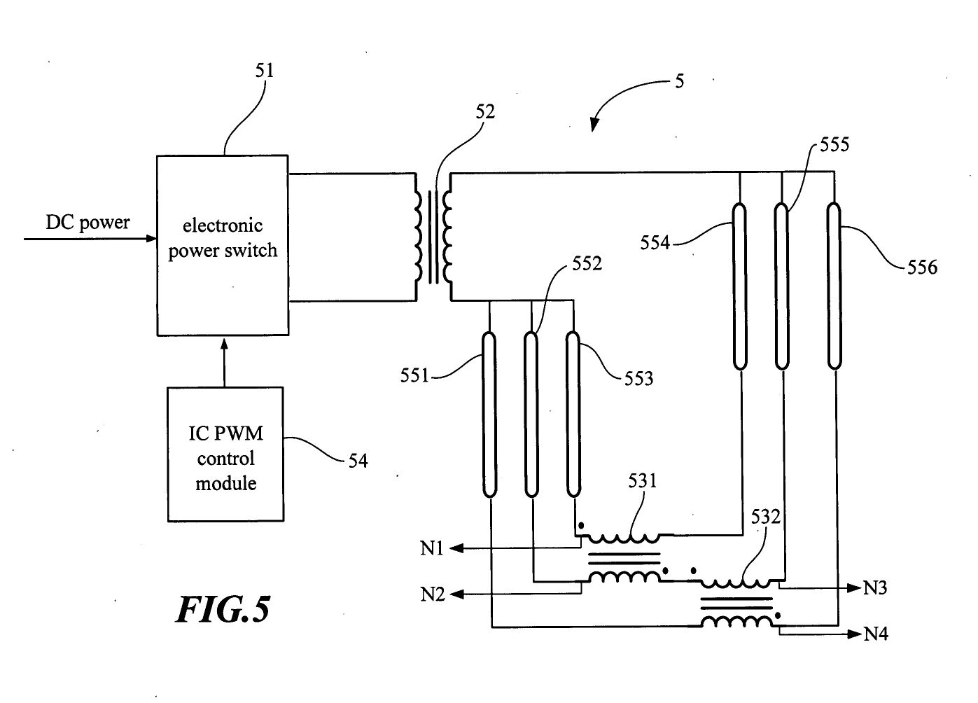

Referring to FIG. 5, a circuit diagram of a control device for multiple lamp currents of a LCD backlight source according to a fourth embodiment of the present invention is shown therein. As shown, the control device 5 comprises an electronic power switch 51, a transformer 52, a first inverter 531 and a second inverter 532 and an IC PWM control module 54. The transformer 52 has a primary side and a secondary side, the primary side being connected to the electronic power switch 51 and the secondary side having two ends, with one end connected to one end of a set of lamp composed of three lamps 551, 552, 553 and the other end connected to the other end of a set of lamp composed of three lamps 554, 555, 556. The other end of each of the lamps 551, 552, 553, 554, 555, 556 is connected to the first inverter 531 and the second inverter 532, the first inverter 531 having two sets of coil N3,N4 and the second inverter 532 having two sets of coil N1,N2, wherein N1=N2 and N3=N4. The first, second, third, fourth, fifth and sixth lamps 551, 552, 553, 554, 555, 556 are connected to an output end of the coil N4, an output end of the coil N2, an input end of the coil N1, an output end of the coil N1, an input end of the coil N3 and an input end of the coil N4, respectively. By means of the inverter 53, the current flown through each of the four lamps 551, 552, 553, 554 is balanced. Further, the IC PWM control module 54 is connected to the electronic power switch 51 so as to control the signal issued from the electronic power switch 51. As such, the luminance of the multiple lamps may be controlled and maintained.

In view of the above, the control device for the multiple lamps of the LCD backlight source may template those each with one transformer and (N/2)−1 inverters for controlling N lamps.

<Features and Efficacies>

As compared to the prior art, the control device for the multiple lamp currents of the LCD backlight source provides at least the following merits: 1. The multiple lamp currents in the LCD backlight source may be efficiently balanced and luminance of the lamps may be controlled and maintained. 2. The control device for the multiple lamp currents of the LCD backlight source is provided with the advantages of higher stability, lengthened lifetime, reduced cost, smaller transformer and saved layout space.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A control device for multiple lamp currents of a light liquid display (LCD) backlight source, comprising:
an electronic power switch receiving a direct current (DC) power signal;
a transformer having a primary side and a secondary side, the primary side being connected to the electronic power switch and the secondary side having two ends each connected to one end of a set of lamp composed of two lamps being a first, second, third and fourth lamps;
an inverter having two sets of coil (N1 and N2) and connected to the other end of each of the first, second, third and fourth lamps; and
an IC PWM control module outputting a control signal to the electronic power switch so as to control the signal issued from the electronic power switch and thus control and maintain a luminance of the multiple lamps.

2. The control device for multiple lamp currents of the LCD backlight source according to claim 1, wherein the coils N1 and N2 has a relationship of N1=N2.

3. The control device for multiple lamp currents of the LCD backlight source according to claim 1, wherein the first, second, third and fourth lamps are connected to an output end of the coil N2, an input end of the coil N1, an output end of the coil N1 and an input end of the coil N2, respectively, and each of the coils N1 and N2 has a reverse current flown therethrough as compared to the other.

4. The control device for multiple lamp currents of the LCD backlight source according to claim 1, further comprising a resistance connected between the transformer and the lamps.

5. A control device for multiple lamp currents of a light liquid display (LCD) backlight source, comprising:
an electronic power switch receiving a direct current (DC) power signal;
a first transformer and a second transformer each having a primary side and a secondary side, the primary side of the first and second transformers being connected to the electronic power switch and the secondary side of each of the first and second transformers having two ends each connected to one end of a set of lamp composed of two lamps being a first, second, third and fourth lamps;
an inverter having two sets of coil (N1 and N2) and connected to the other end of each of the first, second, third and fourth lamps; and
an IC PWM control module outputting a control signal to the electronic power switch so as to control the signal issued from the electronic power switch and thus control and maintain a luminance of the multiple lamps.

6. The control device for multiple lamp currents of the LCD backlight source according to claim 5, wherein the coils N1 and N2 has a relationship of N1=N2.

7. The control device for multiple lamp currents of the LCD backlight source according to claim 5, wherein the first, second, third and fourth lamps are connected to an output end of the coil N2, an input end of the coil N1, an output end of the coil N1 and an input end of the coil N2, respectively, and each of the coils N1 and N2 has a reverse current flown therethrough as compared to the other.

8. A control device for multiple lamp currents of a light liquid display (LCD) backlight source, comprising:
an electronic power switch receiving a direct current (DC) power signal;
a transformer having a primary side, a secondary side connected to a first output coil and a second output coil, the primary side being connected to the electronic power switch, the first coil being connected to a third and fourth lamps and the second coil being connected to a first and second lamps;
an inverter having two sets of coil (N1 and N2) and connected to the other end of each of the first, second, third and fourth lamps; and
an IC PWM control module outputting a control signal to the electronic power switch so as to control the signal issued from the electronic power switch and thus control and maintain a luminance of the multiple lamps.

9. The control device for multiple lamp currents of the LCD backlight source according to claim 8, wherein the coils N1 and N2 has a relationship of N1=N2.

10. The control device for multiple lamp currents of the LCD backlight source according to claim 8, wherein the first, second, third and fourth lamps are connected to an output end of the coil N2, an input end of the coil N1, an output end of the coil N1 and an input end of the coil N2, respectively, and each of the coils N1 and N2 has a reverse current flown therethrough as compared to the other.

11. A control device for multiple lamp currents of a light liquid display (LCD) backlight source, comprising:
an electronic power switch receiving a direct current (DC) power signal;
a transformer having a primary side and a secondary side having a first end and a second end, the primary side being connected to the electronic power switch, the first and second ends being connected to a set of lamp composed of three lamps, respectively, being a first, second, third, fourth, fifth and sixth lamps third and fourth lamps and the second coil being connected to a first and second lamps;
a first inverter having a set of coil (N1 and N2) and a second inverter having another set of coil (N3 and N4) each connected to the other end of the first, second and third and the fourth, fifth and sixth lamps, respectively; and
an IC PWM control module outputting a control signal to the electronic power switch so as to control the signal issued from the electronic power switch and thus control and maintain a luminance of the multiple lamps.

12. The control device for multiple lamp currents of the LCD backlight source according to claim 8, wherein the coils N1 and N2 have a relationship of N1=N2 and the coils N3 and N4 have a relationship of N3=N4.

13. The control device for multiple lamp currents of the LCD backlight source according to claim 11, wherein the first, second, third, fourth, fifth and sixth lamps are connected to an output end of the coil N4, an output end of the coil N2, an input end of the coil N1, an output end of the coil N1, an input end of the coil N3 and an input end of the coil N4, respectively.

14. The control device for multiple lamp currents of the LCD backlight source according to claim 11, wherein the control device is allowed to be provided with a transformer and (N/2)−1 inverters for controlling N lamps.
